(19) United States
(12) Patent Application Publication
(10) Pub. No.: US 2016/0258315 A1
(43) Pub. Date: Sep. 8, 2016

(54) HIGH-CYCLE, SHORT RANGE-OF-MOTION LINKAGE APPARATUS FOR GAS TURBINE ENGINE APPLICATIONS

(71) Applicant: Roller Bearing Company of America, Inc., Oxford, CT (US)

(72) Inventors: Sean Vintinner, Tustin, CA (US); Samuel A. Nunn, Lake Forest, CA (US)

(73) Assignee: Roller Bearing Company of America, Inc., Oxford, CT (US)

(21) Appl. No.: 15/007,939

(22) Filed: Jan. 27, 2016

Related U.S. Application Data
(63) Continuation-in-part of application No. 13/707,166, filed on Dec. 6, 2012, now abandoned.
(60) Provisional application No. 61/567,318, filed on Dec. 6, 2011.

(51) Int. Cl. F01D 17/14; F02K 1/12; F01D 17/10; F02K 3/02; F01D 9/04

(52) U.S. Cl. CPC F01D 17/14; F02K 3/02; F01D 9/041; F01D 17/105; F02K 1/12; F01D 17/145; F05D 2220/323; F05D 2240/54; F05D 2260/50

(57) ABSTRACT

A high-cycle, short range-of-motion linkage apparatus for actuation of a turbofan engine component includes a pivot member having a head portion and a stem, and an actuator moveable between a first and second position. An actuator first end defines a receiving portion into which the stem is removably secured. An actuator second end defines a coupling member pivotally connected to a turbofan engine structural member and moveable between a first and second position corresponding to the actuator first and second positions. A spherical plain bearing pivotally connects the pivot member head to the turbofan engine component and includes an inner member, an outer member swaged around the inner member and disposed between the inner member and the head of the pivot member, and a liner disposed between the inner and outer members. The outer member defines a range of motion in relation to the inner member up to 90°.

### CROSS-REFERENCE TO RELATED APPLICATION

This application is a Continuation-In-Part of copending U.S. patent application Ser. No. 13/707,166 filed on Dec. 6, 2012, which application is incorporated herein by reference in its entirety, and which application claims the benefit of U.S. Provisional Patent Application Ser. No. 61/567,318 filed on Dec. 6, 2011, which application is incorporated herein by reference in its entirety.

### TECHNICAL FIELD

The present invention is directed to bearings and, more particularly, to swaged self-lubricating bearings for use in high-cycle, short range-of-motion linkages for gas turbine engines.

### BACKGROUND

Spherical plain bearings typically comprise a ball positioned for rotational movement in an outer race. The outer race defines an inner surface contoured to receive and retain the ball therein. In one type of spherical plain bearing, the outer race is swaged around the spherical outer surface of the ball. In some cases, particularly those in which the ball and the outer race are each metallic and in which there is metal-on-metal contact, however, the outer race may be constructed with a slot to permit insertion of the ball. Such bearings are referred to as “load slot bearings.”

Bearings in which there is metal-on-metal contact are generally used in environments in which marked variations in pressure, temperature, and high frequency vibrations are experienced. However, such variations in pressure, temperature, and high frequency vibrations can result in the bearings exhibiting high levels of wear. Moreover, high-cycle metal-on-metal contact or engagement within a short range-of-motion exacerbates the high levels of wear. Also, in these environments, foreign objects can impinge on the bearings, and contaminants such as dust, dirt, water, and aerospace fluids can be encountered, all of which can contribute to bearing wear. Additionally, high temperatures and pressures can cause severe oxidation or other forms of corrosion on the metal surfaces. Worn and oxidized bearings generate significant increases in friction and overload the interfacing hardware, which can lead to low cycle fatigue (LCF) stress problems where the interfacing hardware can also fail.

### SUMMARY

In one aspect, the present invention resides in a high-cycle, short range-of-motion linkage apparatus for actuation of a turbofan engine component, the linkage apparatus comprising: a pivot member having a head portion and a stem extending therefrom; an actuator moveable between at least a first position and a second position and having a first end and a second end, the actuator first end defining a receiving portion into which the stem is removably secured, the actuator second end defining a coupling member, the coupling member pivotally connected to a turbofan engine structural member and moveable between at least a first position and a second position respectively corresponding to the actuator first and second positions; and a spherical plain bearing secured within the head portion of the pivot member and pivotally connected to the turbofan engine component, the spherical plain bearing comprising, an inner member having an outer engagement surface and a first bore extending at least partway therethrough, an outer member swaged around the inner member, the outer member disposed between the inner member and the head portion of the pivot member, the outer member having an inner engagement surface contoured to a shape complementary to the outer engagement surface of the inner member, a liner disposed between the inner engagement surface of the outer member and the outer engagement surface of the inner member, and a shaft extending into the first bore and at least one corresponding aperture in the turbofan engine component; the spherical plain bearing outer member having a range of motion in relation to the spherical plain bearing inner member in the range of up to 90°; and a second shaft extending into a second bore defined in the coupling member and at least one corresponding aperture in the turbofan engine structural member.

In another aspect, the present invention resides in a high-cycle, short range-of-motion linkage apparatus for actuation of a turbofan engine component linkage assembly, the linkage apparatus comprising: a pivot member having a head portion and a stem extending therefrom; an actuator moveable between at least a first position and a second position and having a first end and a second end, the actuator first end defining a receiving portion into which the stem is removably secured, the actuator second end defining a coupling member moveable between at least a first position and a second position respectively corresponding to the actuator first and second positions; a spherical plain bearing secured within the head portion of the pivot member and operable within an operating temperature range of about 260° C. (500° F.) to about 315° C. (600° F.), the spherical plain bearing comprising, an inner member having an outer engagement surface and a first bore extending at least partway therethrough, an outer member swaged around the inner member, the outer member disposed between the inner member and the head portion of the pivot member, the outer member having an inner engagement surface contoured to a shape complementary to the outer engagement surface of the inner member, a liner comprising polytetrafluoroethylene and a polyimide resin reinforced with aramid fibers having an operating temperature range of about 260° C. (500° F.) to about 315° C. (600° F.) and disposed between the inner engagement surface of the outer member and the outer engagement surface of the inner member, and the spherical plain bearing outer member having a range of motion in relation to the spherical plain bearing inner member in the range of up to 90°; and a first shaft extending into the first bore and at least one corresponding aperture in the turbofan engine component linkage assembly and pivotally connecting the actuator first end to the turbofan engine component linkage assembly; and a second shaft extending into a second bore defined in the coupling member and at least one corresponding aperture in a turbofan engine structural member linkage assembly and pivotally connecting the coupling member to the turbofan engine structural member linkage assembly.

### BRIEF DESCRIPTION OF THE DRAWINGS

FIG. 1 is a side cross-sectional view of a bearing of the present invention.

FIG. 2 is a side cross-sectional view of one embodiment of a linkage apparatus of the present invention into which the bearing of FIG. 1 is mounted.

FIG. 3 is an exploded perspective view of one embodiment of mounting the linkage apparatus of FIG. 2 to a structural member.

FIG. 4 is a side cross-sectional view of another embodiment of the linkage apparatus of FIG. 2 into which the bearing of FIG. 1 is mounted into a first end and a second end of the linkage apparatus.

FIG. 5 is a side cross-sectional view of another embodiment of the linkage apparatus of FIG. 2 comprising a pneumatic actuator.

FIG. 6A is a perspective view of one embodiment of a positioning member of the present invention which is engaged by a linkage apparatus of the present invention.

FIG. 6B is a top plan view of another embodiment of a positioning member of the present invention, namely, a turbofan engine variable stator vane actuator ring assembly, which is engaged by two of the linkage apparatuses of the present invention.

FIG. 6C is a perspective view of another embodiment of a positioning member of the present invention, namely, a turbofan engine variable bypass valve assembly, which is engaged by a linkage apparatus of the present invention.

FIG. 7 is an exploded perspective view of another embodiment of a positioning member of the present invention, namely, a turbofan engine component case, which is engaged by a linkage apparatus of the present invention.

FIG. 8 is an exploded perspective view of another embodiment of a turbofan engine component case which is engaged by two of the linkage apparatuses of the present invention.

FIG. 9 is a perspective view of a variable exhaust nozzle for an afterburner on a turbofan engine, the variable exhaust nozzle comprising a plurality of the linkage apparatuses of the present invention.

FIG. 10 is an exploded perspective view of a plate and the plurality of linkage apparatuses of the variable exhaust nozzle of FIG. 9.

FIG. 11 is an exploded schematic view of a linkage apparatus of the present invention pivotally connected to a structural member of a turbofan engine.

FIG. 12 is an exploded schematic view of a linkage apparatus of the present invention and pivotally connected to a linkage bracket that is pivotally connected to a structural member of a turbofan engine.

### DETAILED DESCRIPTION

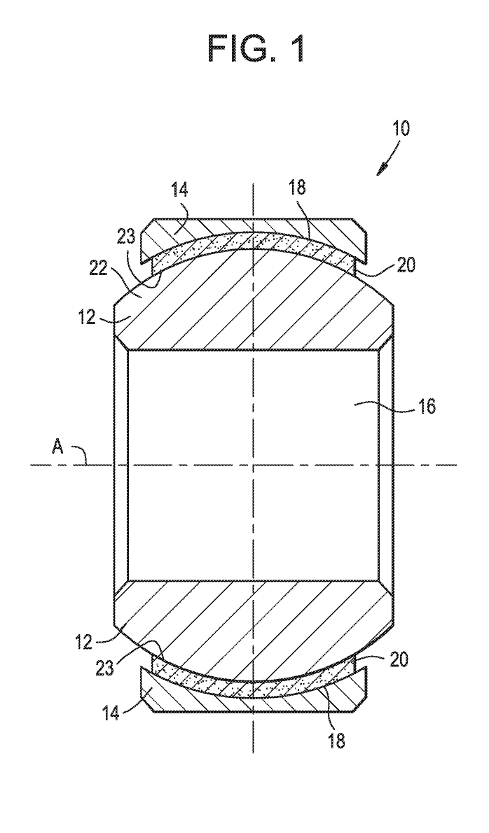

As shown in FIG. 1, a spherical plain bearing assembly of a swaged configuration is designated generally by the reference number 10 and is hereinafter referred to “bearing assembly 10.” Bearing assembly 10 includes an inner member or a ball 12 positioned in an outer member or an outer race 14. A central axis A is defined through the bearing assembly 10. The ball 12 defines an outer surface 22, a portion of which is an outer engagement surface 23. The ball 12 further defines a bore 16 extending therethrough and adapted to receive a portion of a shaft or other component therein. The present invention is not so limited, as the ball 12 may be integral with or form part of a shaft or other component. Moreover, while the bore 16 is shown and described as extending through the ball 12, the present invention is not limited in this regard as the bore can extend part-way through the ball, the bore may define a stepped-bore, or the ball may not define a bore without departing from the broader aspects of the invention.

In the illustrated embodiment, the outer race 14 is a ring having an inner surface, a portion of which is an inner engagement surface 18 on which a self-lubricating liner 20 is disposed. The inner engagement surface 18 is contoured to a shape complementary to the outer engagement surface 23 of the ball 12. As shown, at least a portion of the inner engagement surface 18 is concave, and at least a portion of the outer surface of the ball is convex. When the ball 12 is located in the outer race 14, the outer surface 22 engages the liner 20. While the outer race 14 has been shown and described as being a ring, the present invention is not limited in this regard as the outer race can assume any practical shape or be part of another component, such as, for example a housing, without departing from the broader aspects of the invention.

The ball 12 is made from any suitable material, such as metal or alloys. Suitable metals and alloys from which the ball 12 may be fabricated include, but are not limited to, stainless steels (e.g., 440C, A286, and the like), nickel-chromium-based superalloys (e.g., Inconel and the like), titanium, titanium alloys, silicon nitride, silicon carbide, zirconium, and the like.

The outer race 14 is made from any suitable material, such as metal or alloys. Suitable metals from which the outer race 14 may be fabricated include, but are not limited to, stainless steels (e.g., 17-4 PH® stainless steel), titanium, titanium alloys, and the like. The present invention is not so limited, however, as ceramics may be used in the construction of the outer race 14.

The liner 20 on the inner engagement surface 18 comprises a polytetrafluoroethylene (“PTFE”) and a phenolic resin reinforced with aramid fibers. More particularly, the liner 20 comprises PTFE and a layer of low-friction material, namely, a phenolic resin reinforced with aramid fibers (such as Nomex®, available from E. I. du Pont de Nemours and Company, Wilmington, Del.). The fiber may comprise a plain, twill or satin weave. The present invention is not limited to the use of aramid fibers, however, as other fibers including, but not limited to, glass, polyester, glass woven with Teflon®, and carbon fibers are within the scope of the present invention. The use of PTFE and phenolic resin reinforced with aramid fibers provides for toughness, high wear resistance, and protection against dynamic, high frequency vibratory loads.

The liner 20 is suited for use in moderate to high temperature environments and is particularly suited for use in turbofan engines. The resin used to formulate the liner 20 could be phenolic for moderate temperature applications in the range of about 150° C. (300° F.) to about 260° C. (500° F.), and polyimide for higher temperature applications in the range of about 260° C. (500° F.) to about 315° C. (600° F.). For lower temperature applications up to about 175° C. (350° F.), the liner 20 may be fabricated as a homogenous machinable liner formulated from a curable acrylate composition with various fillers for structure and PTFE for lubrication. The liner 20, however, is not limited to PTFE and a phenolic resin reinforced with aramid fibers and may comprise other material(s) suitable for use in the moderate to high temperature environments in which the bearing assembly 10 is to be used. Other liners that may be used include, but are not limited to, those with different fabric reinforcements, machinable materials (for example, materials without fabric reinforcement but with other reinforcement structures), and other self-lubricating materials that may include polyimide resins. Additionally, the liner 20 could be attached to supporting structure without the outer race 14.

During operation of the bearing assembly 10, the liner 20 on the inner engagement surface 18 of the outer race 14 engages the outer engagement surface 23 of the ball 12, thereby causing the ball 12 to move slidably and rotatably relative to the outer race 14. The liner 20 is particularly suited for high-cycle engagement within a short range-of-motion. A high-cycle angular range-of-motion of the outer race 14 in relation to the ball 12 can range from 0° up to 90°, 270° and 360°. In particular, such high-cycle angular range-of-motion can range from about 15° to about 45°. More particularly, such high-cycle angular range-of-motion can range from about 5° to about 10°. Accordingly, the bearing assembly 10 is particularly suited for high-cycle engagement within a short range-of-motion for moderate temperature applications in the range of about 150° C. (300° F.) to about 260° C. (500° F.), and for higher temperature applications in the range of about 260° C. (500° F.) to about 315° C. (600° F.).

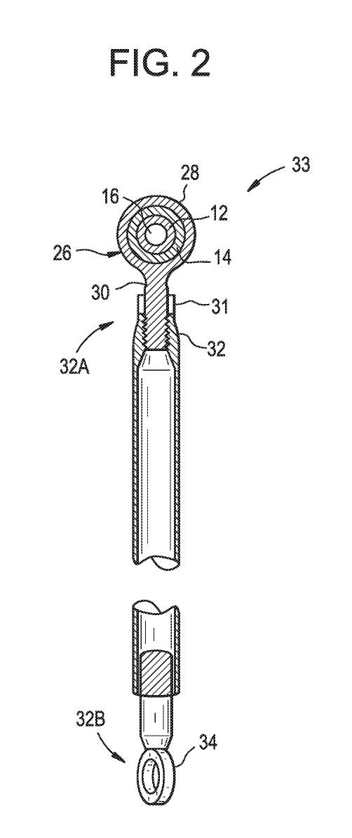

As shown in FIG. 2, the outer race 14 is swaged around the ball 12, one of which has the liner 20 disposed thereon, for example, by swaging the bearing assembly 10 into a pivot member or socket 26 for use in aircraft, aerospace, heavy equipment, or vehicular applications. The socket 26 has a head portion 28 and a neck or stem 30 extending therefrom that is removably secured or threadedly received in a receiving portion 31 of a positioning member 32, moveable between at least a first position and a second position and thereby defining a linkage apparatus 33. The bearing assembly 10 engages or is pivotally connected to a turbofan engine component or a turbofan engine component linkage assembly moveable between at least a first position and a second position corresponding to the first and second positions of the linkage apparatus 33. The positioning member 32 defines a first end 32A defining the receiver portion 31 into which the stem 30 is removably secured, and a second end 32B defining a coupling member 34 for coupling the position member 32 to a turbofan engine structural member or a turbofan engine structural member linkage assembly. The coupling member 34 may be press fit into second end 32B of the positioning member 32. Although the coupling member 34 has been described as being press fit into the second end 32B of the positioning member 32, other methods for securing the coupling member 34 within the second end 32B of the positioning member 32, such as, for example, by threaded engagement, pins and corresponding apertures and other like fastening means, or by cooling the coupling member 34 and heating the coupling member 34, are considered within the scope of the invention.

The link apparatus 33 is especially suitable for use in pneumatic actuators, variable geometry systems, and as support links for accessories. In addition, the link apparatus 33 is particularly suitable as a high-cycle, short range-of-motion linkage apparatus for actuation of one or more positioning devices. Said positioning devices particularly include turbofan engine component linkages, such as, for example, a turbofan engine component case, a variable stator vane (“VSV”) actuator ring assembly, and a variable exhaust nozzle for an afterburner or augmentor on a turbofan engine. The present invention is not limited in this regard, as the link apparatus 33 may be used in other applications as described below.

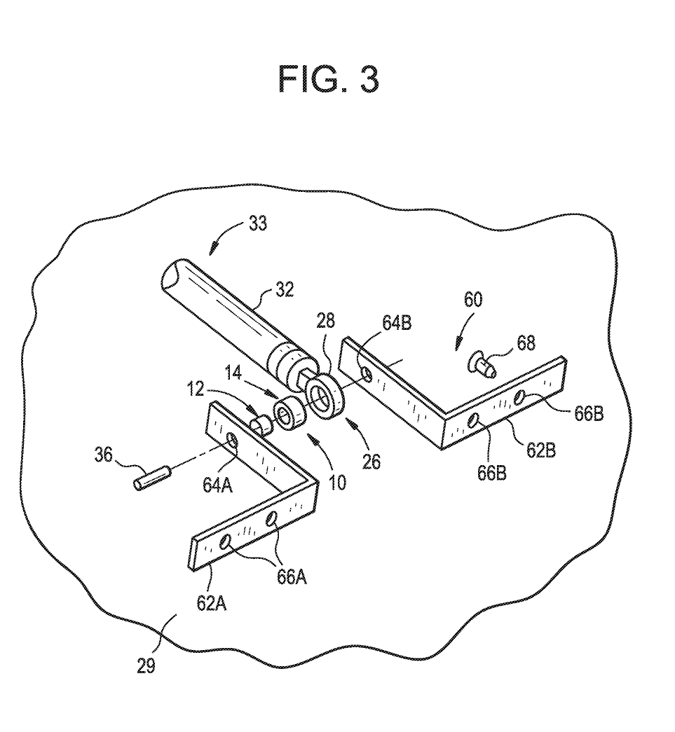

As shown in FIG. 3, one embodiment of mounting the linkage apparatus 33 to the structural member 29 includes coupling the linkage apparatus 33 to a mounting assembly 60 that is, in turn, removeably and securely fastened to the structural member 29. The ball 12 and the outer race 14 of the bearing assembly 10, one of which has the liner 20 disposed thereon, is swaging into the head portion 28 of the socket 26. The bearing assembly 10 is pivotally connected to a pair of mounting brackets 62A and 62B via a shaft or pin 36 extending through the bearing assembly 10. The pin 36 is secured in the bore 16 of the bearing assembly 10 and a pair of apertures 64A and 64B defined respectively in the mounting brackets 62A and 62B via a press fit. The press fit, also known as an interference fit or friction fit, is maintained by friction after the pin 36 has been pushed or driven into the bore 16 and the apertures 64A and 64B by a process such as staking. In one embodiment, the pin 36 is slightly undersized thereby creating an initial slip fit within the bore 16 and the apertures 64A and 64B. A staking punch is then used to compress the pin 36 radially and thereby form the press fit or interference fit between the pin 36 and the bore 16 and the apertures 64A and 64B. The press fit relies upon the tensile and compressive strengths of the materials from which the respective parts are fabricated. Although the pin 36 has been described as being press fit or staked into the bore 16 and the apertures 64A and 64B, other methods for engaging the pin 36 within the bore 16 and the apertures 64A and 64B, for example, by cooling the pin 36 and heating the bore 16 and the apertures 64A and 64B, are considered within the scope of the invention. In addition, the pin 36 may be integrally formed with the ball 12.

Each of the mounting brackets 62A and 62B are removeably and securely fastened to the structural member 29 by fasteners 68 (only one fastener 68 shown) threadedly received within correspondingly tapped apertures (not shown) in the structural member 29. The present invention is not limited in this regard as the fasteners 68 may comprise a pin that is press fit into corresponding apertures in the structural member 29, the press fit being as described hereinabove with respect to the pin 36, the bore 16 and the apertures 64A and 64B. While fasteners 68 are shown and described for removeably and securely fastening the mounting brackets 62A and 62B to the structural member 29, the present invention is not limited in this regard as the mounting brackets 62A and 62B may be fixedly connected to the structural member 29 by any number of material joining means, such as, for example, use of suitable adhesives, welding, or being integrally forged or cast therewith, may also be employed without departing from the broader aspects of the invention.

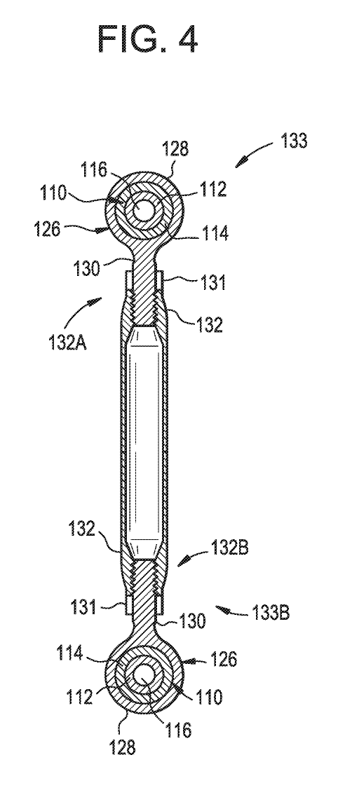

A linkage apparatus 133 is depicted in FIG. 4 and is similar to the linkage apparatus 33 shown in FIG. 2, thus like elements are given a like element number preceded by the numeral 1.

As shown in FIG. 4, the linkage apparatus 133 comprises a positioning member 132 that defines a first end 132A and a second end 132B. Both the first and second ends 132A and 132B of the positioning member 132 each comprise a pivot member or socket 126 having a head portion 128 and a stem 130 extending therefrom that is removably secured or threadedly received in a receiving portion 131 of the positioning member 132. Each of the sockets 126 have a bearing assembly 110 swaged therein, each of the bearing assemblies 110 comprising a ball 112 defining a bore 116 therethrough, an outer race 114 and a liner (not shown) disposed between the ball 112 and the outer race 114. Thus, the linkage apparatus 133 comprises bearing assemblies 110 swaged into sockets 126 at a first end 133A and a second end 133B of the linkage apparatus 133.

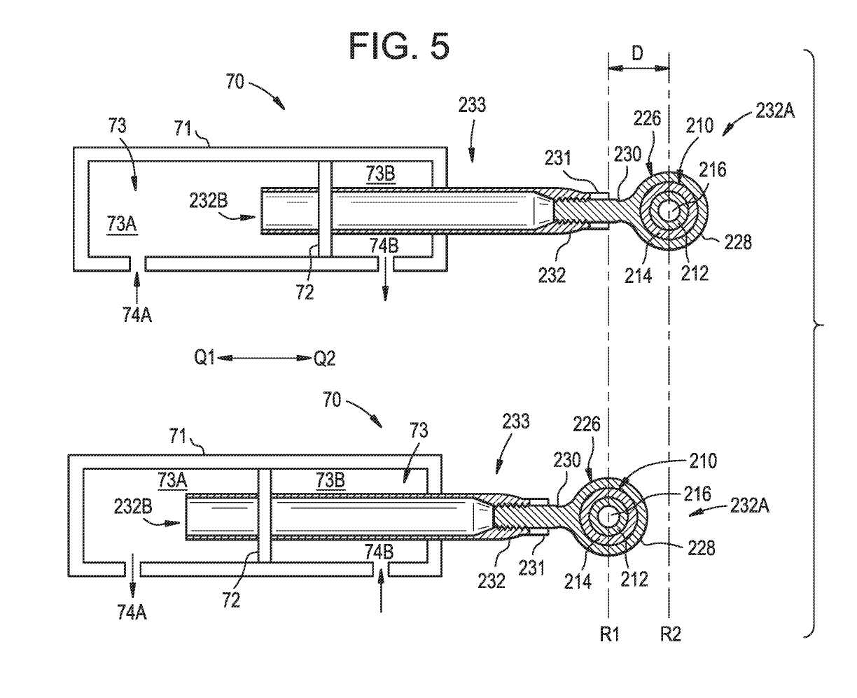

A linkage apparatus 233 for actuation of a positioning device is depicted in FIG. 5 and is similar to the linkage apparatus 33 shown in FIG. 2, thus like elements are given a like element number preceded by the numeral 2.

The linkage apparatus 233 depicted in FIG. 5 comprises an actuator such as, for example, a pneumatic actuator 70, that is shown in a retracted configuration or retracted position R1 and an extended configuration or extended position R2. The actuator 70 comprises an actuator housing 71 and the linkage apparatus 233 comprises a positioning member 232 that defines a first end 232A and a second end 232B. The first end 232A of the positioning member 232 comprises a pivot member or socket 226 having a head portion 228 and a stem 230 extending therefrom that is removably secured or threadedly received in a receiving portion 231 of the positioning member 232. The socket 226 has a bearing assembly 210 swaged therein comprising a ball 212 defining a bore 216 therethrough, an outer race 214 and a liner (not shown) disposed between the ball 212 and the outer race 214.

The second end 232B of the linkage apparatus 233 is fixedly secured to a moveable block, plunger or piston 72 of the actuator 70 for actuation of the positioning device (not shown). The piston 72 divides an interior volume 73 of the actuator housing 71 into a first interior volume 73A and a second interior volume 73B. The actuator housing 71 is fitted within a vessel or a cylinder (not shown) in which a hydraulic fluid is in communication with the interior volume 73 of the actuator housing 71. The actuation of the positioning device is initiated when the piston 72 and the linkage apparatus 233 is in the retracted position R1.

In operation, the hydraulic fluid is pumped into the first interior volume 73A via a port 74A formed in the housing 71, at a Pressure P1, and a corresponding amount of hydraulic fluid is released from the second interior volume 73B via a port 74B formed in the housing 71, at a Pressure P2 which is less than Pressure P1. The influx of the hydraulic fluid into the first interior volume 73A (and the corresponding release of hydraulic fluid from the second interior volume 73B) causes the piston 72 to advance in a direction indicated by the arrow Q2 thereby extending the linkage apparatus 233 in the direction Q2 such that the bearing assembly 210 advances a distance D in the direction Q2 thereby extending or actuating a positioning device. Similarly, the hydraulic fluid is pumped into the second interior volume 73B via the port 74BA, at a Pressure P1, and a corresponding amount of hydraulic fluid is released from the first interior volume 73A via the port 74A, at a Pressure P2 which is less than Pressure P1. The influx of the hydraulic fluid into the second interior volume 73B (and the corresponding release of hydraulic fluid from the first interior volume 73A) causes the piston 72 to retract in a direction indicated by the arrow Q1 thereby retracting the linkage apparatus 233 in the direction Q1 such that the bearing assembly 210 retracts the distance D in the direction Q1 thereby retracting or de-actuating the positioning device. The force that acts upon the positioning device is equal to the Pressure P1 of the hydraulic fluid pumped into the interior volume 73 of the housing 71 multiplied by the area of the piston 72. Accordingly, linkage apparatus 233 comprises the actuator 70 having a positioning member 232 that defines a shaft or socket 26 extending therefrom and is operable between the retracted configuration or position R1 and the extended configuration or position R2 to move the positioning 232 member between at least the position R1 and the position R2.

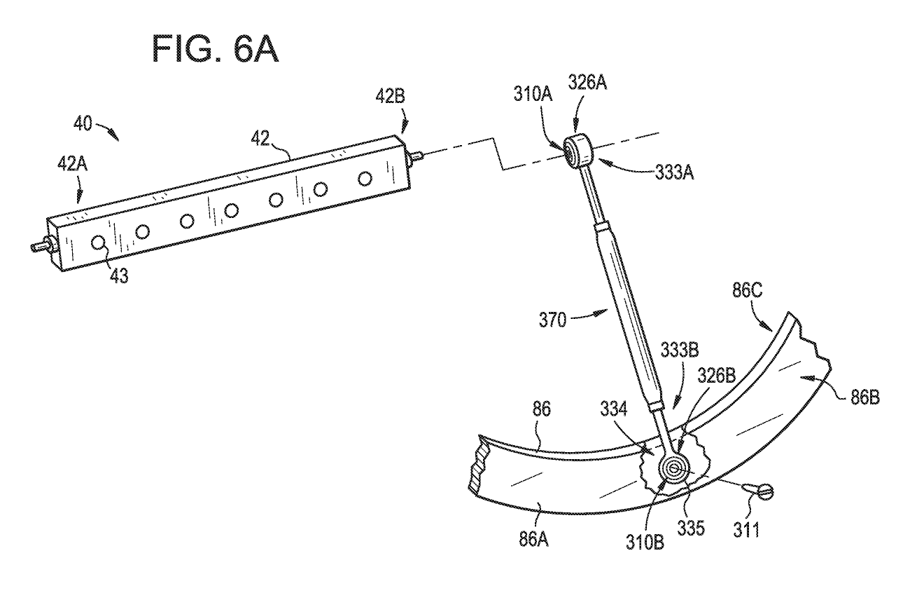

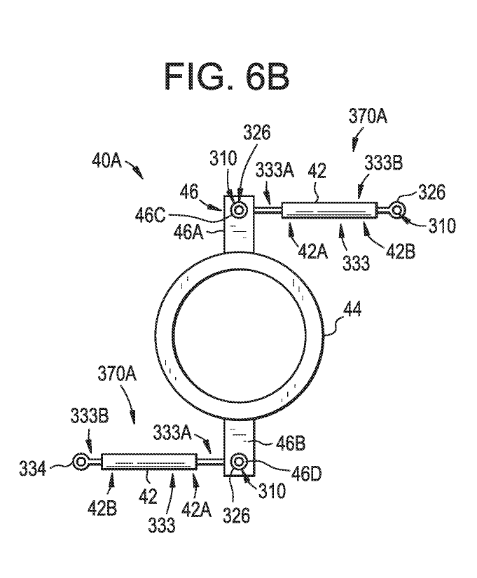

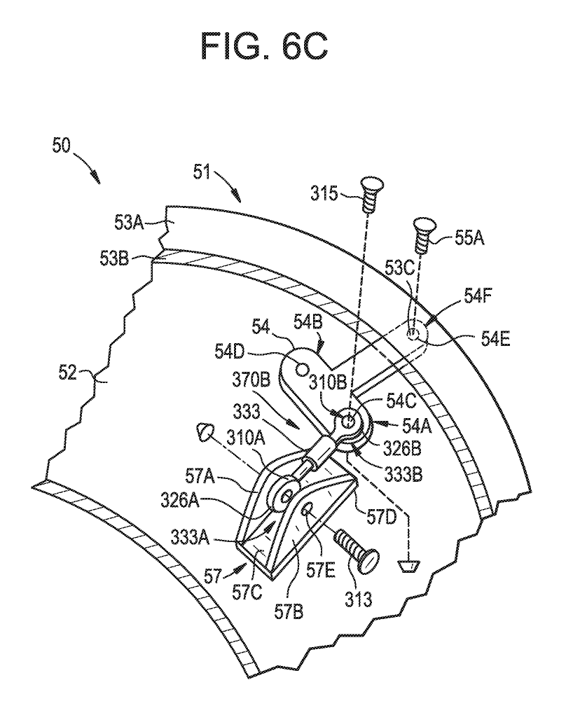

A linkage apparatus 333 for actuation of a positioning device is depicted in FIGS. 6A and 6B and is similar to the linkage apparatus 33 shown in FIG. 2, the linkage apparatus 133 shown in FIG. 4 and the actuator 70 shown in FIG. 5, thus like elements are given a like element number preceded by the numeral 3.

One variable geometry system in which the linkage apparatus 333 may be employed is a VSV actuator system for a turbofan engine as depicted in FIGS. 6A, 6B and 6C. The present invention is not limited to VSV actuator systems for turbofan engines, however, as linkage apparatus 333 may be employed in conjunction with rod ends, bell cranks, linkages, and the like in other systems including, but not limited to, crankshaft systems, systems for the control of bleed and/or bypass air, etc. In the VSV actuator system, a set of stator vanes internal to the engine is adjusted to obtain a smoother air flow through a compressor section of the turbofan engine.

One embodiment of a VSV actuator system is shown generally at 40 in FIG. 6A and is hereinafter referred to as “system 40.” The turbofan engine component of system 40 includes a turbofan engine component linkage assembly configured as a bar 42 having a first end 42A and a second end 42B. A pneumatically operable actuator 370 is received within or fixedly attached to the second end 42B of the bar 42. The actuator 370 is one embodiment of the linkage apparatus 333 and includes a socket 326A having a bearing assembly 310A disposed in a first end 333A thereof as described above with reference to bearing assembly 210 of FIG. 5. A plurality of apertures 43 may be formed in the bar 42 for connecting another respective first end 333A of another respective linkage apparatus 333 (not shown) to the bar 42 wherein each respective first end 333A of each respective linkage apparatus 333 also may include a socket 326 having a bearing assembly 310 disposed therein (not shown).

A second end 333B of the linkage apparatus 333 is received within or fixedly attached to a turbofan engine structural member 86, such as for example, a VSV actuator ring 86A. The structural member 86 defines a first surface 86B (e.g., a top or forward surface) and a second surface 86C (e.g., a bottom or rearward surface). In one embodiment, the second end 333B of the linkage apparatus 333 includes a socket 326B having a bearing assembly 310B disposed therein as described above with reference to bearing assembly 210 of FIG. 5. A shaft 311 is disposed through a first aperture (not shown) in the first surface 86B of the structural member 86, through the bearing assembly 310B, and through a second aperture (not shown) in the second surface 86C of the structural member 86 thereby securing the second end 333B of the linkage apparatus 333 within the structural member 86. In one embodiment, the shaft 311 is a fastener such as for example a bolt-and-nut assembly.

In another embodiment, the second end 333B of the linkage apparatus 333 defines a coupling member 334 as described hereinabove with reference to coupling member 34 of FIG. 2. The shaft 311 is a fastener, such as for example a sleeved bolt-and-nut assembly, and is disposed through the first aperture (not shown) in the first surface 86B of the structural member 86, through the coupling member 334, and through a second aperture (not shown) in the second surface 86C of the structural member 86 thereby securing the second end 333B of the linkage apparatus 333 within the structural member 86. In one embodiment, a second actuator 370 (not shown) is fixedly attached to the first end 42A of the bar 42.

Referring to FIG. 6B, another embodiment of a VSV actuator system is shown generally at 40A and is hereinafter referred to as “system 40A.” The turbofan engine component of system 40A comprises a turbofan engine component linkage assembly configured as an actuator ring 44 defining one or more flanges 46, flanges 46A and 46B as shown in FIG. 6B. In one embodiment, a pneumatically operable actuator 370A is received within or fixedly attached to the each of the flanges 46A and 46B at respective apertures 46C and 46D. The actuator 370A is one embodiment of the linkage apparatus 333 and includes a socket 326 having a bearing assembly 310 disposed in a first end 333A thereof as described above with reference to bearing assembly 210 of FIG. 5. The second end 333B of the linkage apparatus 333 is received within or fixedly attached to a turbofan engine structural member 86 as shown in FIG. 6A and described above with reference thereto. Upon operation of the actuator 370, the flange 46 and/or the actuator ring 44 is moved to adjust the stator vanes (not shown) in the turbofan engine. The bearing assemblies 310 in the sockets 326 allow for the desired operation of the system 40 at the temperatures encountered in the turbofan engine.

Another variable geometry system in which the linkage apparatus 333 may be employed is a variable bypass valve (“VBV”) assembly for a turbofan engine as depicted in FIG. 6C. The VBV assembly is shown generally at 50 and is hereinafter referred to as “system 50.” Along with the VSV actuator system, system 40, the VBV assembly, system 50, is employed to obtain a smoother air flow through a compressor section of the turbofan engine by allowing a specified amount of air to bypass a stator vane assembly or stage. Referring to FIG. 6C, the turbofan engine component of system 50 comprises a ring such as the actuator ring 44 (FIG. 6B), or another disc or actuator ring 51, or like component of a stator vane assembly or stage. The actuator ring 51 defines a base 52 that typically extends radially outward from a turbine shaft (not shown) or other turbofan engine component that extends axially along a centreline of the turbofan engine. The actuator ring 51 further defines a flange 53A along its radially inner facing periphery that defines an axially extending channel 53B. A turbofan engine component linkage assembly configured as a T-bracket 54 is positioned within the channel 53B and is pivotally connected thereto via a fastener 55A. A VBV door assembly 57 includes flanges 57A and 57B each having an aperture 57E therein, a door flap 57C rotatably connected on one side to the base 52 of the actuator ring 51 via a hinged connection 57D. A pneumatically operable actuator 370C is pivotally connected to a first end 54A of the T-bracket 54.

The actuator 370C is one embodiment of the linkage apparatus 333 and defines a first end 333A thereof having a socket 326A and a bearing assembly 310A disposed therein as described above with reference to bearing assembly 210 of FIG. 5. A shaft 313 is disposed through the aperture 57E in the flange 57A, through the bearing assembly 310A, and through the aperture 57E in the flange 57B. In one embodiment, the shaft 311 is a fastener such as for example a bolt-and-nut assembly. The linkage apparatus 333 defines a second end 333B having a socket 326B and a bearing assembly 310B disposed therein as described above with reference to bearing assembly 210 of FIG. 5. A shaft 315 is disposed through the bearing assembly 310B and through a first aperture 54C in the T-bracket 54. In one embodiment, the shaft 315 is a fastener such as for example a bolt-and-nut assembly. The T-bracket 54 may define one or more apertures 54D for pivotally connecting the T-bracket 54, for example at a second end 54B, to another linkage apparatus 333 or another turbofan engine structural member. The T-bracket 54 includes an aperture 54E disposed in a third end 54F corresponding to an aperture 53C disposed in the flange 53A of the ring 51. A fastener 55A extends through the aperture 54E and 53C thereby pivotally connecting the T-bracket 54 to the flange 53A of the ring 51.

Upon operation of the actuator 370B, the T-bracket 54 rotates about the fastener 55A connecting the T-bracket 54 to the flange 53A, and in turn the linkage apparatus 333 acts upon the VBV door assembly 57 such that it rotates upwardly, or axially outwardly, from the base 52 thereby exposing an opening or cavity in the base 52 through which bypass air will flow. The VBV assembly 50 allows for the desired operation of the VBV door assembly 57 at the temperatures encountered in the turbofan engine by defining one of a partially open air flow condition and a closed air flow condition.

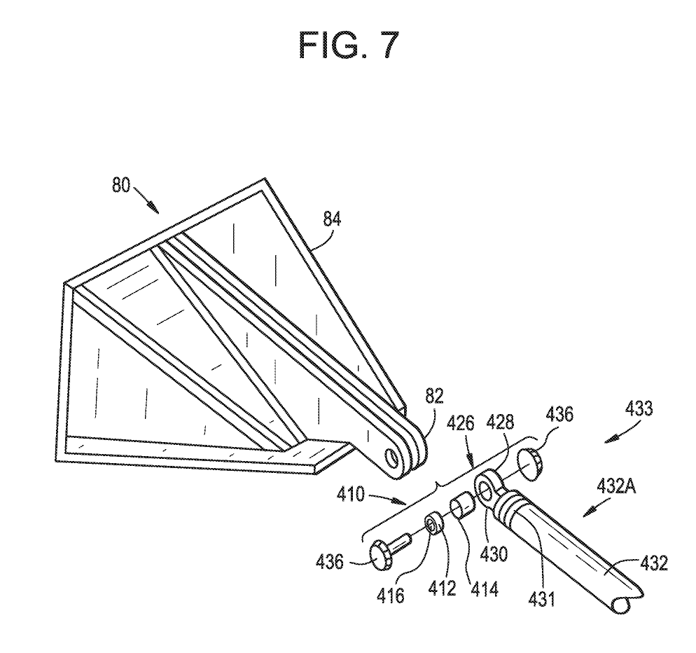

A linkage apparatus 433 for actuation of a positioning device is depicted in FIG. 7 and is similar to the linkage apparatus 33 shown in FIG. 2, thus like elements are given a like element number preceded by the numeral 4.

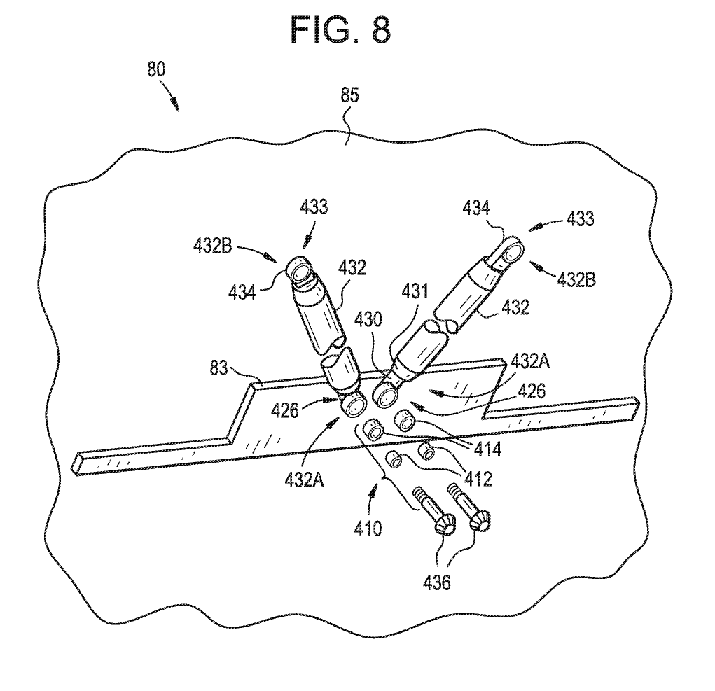

As shown in FIGS. 7 and 8, the linkage apparatus 433 comprises a positioning member 432 that defines a first end 432A and a second end 432B (shown in FIG. 8). The first end 432A of the positioning member 432 comprises a pivot member or socket 426 having a head portion 428 and a stem 430 extending therefrom that is removably secured or threadedly received in a receiving portion 431 of the positioning member 432. The socket 426 has a bearing assembly 410 swaged therein comprising a ball 412 defining a bore 416 therethrough, an outer race 414 and a liner (not shown) disposed between the ball 412 and the outer race 414. As shown in FIG. 7, the bearing assembly 410 of the linkage apparatus 433 is pivotally connected to a flange 82 fixedly attached to, or integrally formed with, and extending from a housing 84 of a turbofan engine component 80. As shown in FIG. 8, more than one linkage apparatus 433 can be independently coupled or pivotally connected to a flange 83 fixedly attached to, or integrally formed with, and extending from a housing 85 of the turbofan engine component 80. Said turbofan engine component 80 may comprise, for example, an oil cooler, and air cooler, or an integrated oil/air cooler.

The bearing assembly 410 is pivotally connected to the flange 82 or 83 via a shaft or pin 436 as described above with reference to pivotally connecting the bearing assembly 10 to the mounting brackets 62A and 62B via a shaft or pin 36 extending through the bearing assembly 10, and the like, as depicted in FIG. 3. A coupling member 434 (FIG. 8; not shown in FIG. 7) or another socket (not shown) extends from the second end 433B of each of the linkage apparatuses 433 and is removeably and securely fastened to a structural member (not shown) as described above with reference to structural member 86 of FIG. 6A. The bearing assembly 410 accommodates movement of the turbofan engine component 80 relative to other turbofan engine components or structural members during operation of the turbofan engine. Linkage apparatuses 433 incorporating sockets 426 and bearing assemblies 410 may be employed as link apparatuses for accommodating movement of any turbofan engine component during operation of the turbofan engine.

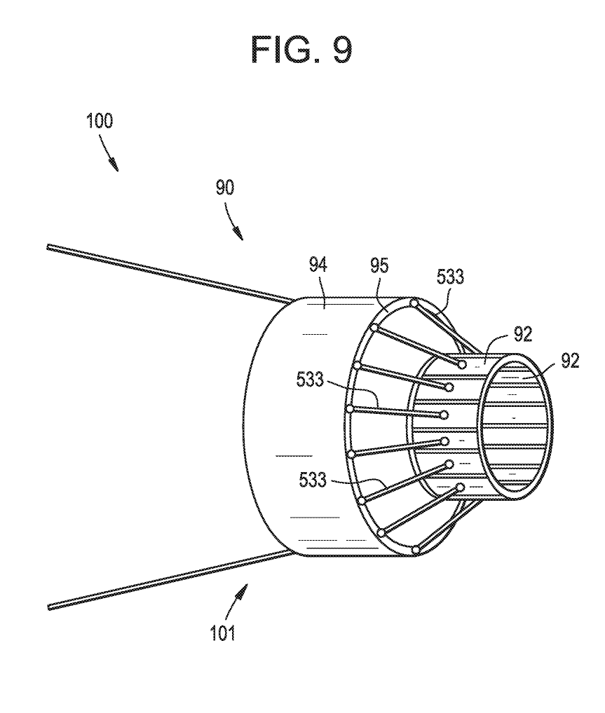

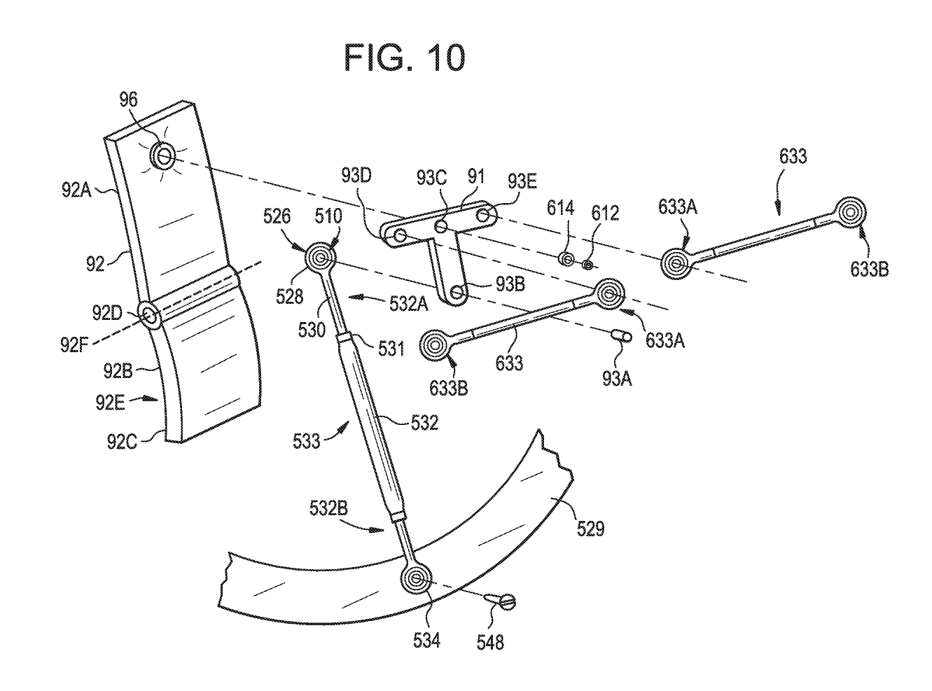

A plurality of linkage apparatuses 533 and 633 for actuation of a positioning device are depicted in FIGS. 9 and 10 and is similar to the linkage apparatus 33 shown in FIG. 2, the linkage apparatus 133 shown in FIG. 4, and the actuator 70 shown in FIG. 5, thus like elements are given a like element number preceded by the numerals 5 and 6.

As shown in FIG. 9, an augmentor 101 of a turbofan engine 100 includes a turbine engine component, namely, a variable exhaust nozzle 90. The augmentor 101 is an afterburner installed on the turbofan engine 100, particularly a low-bypass turbofan engine, and is used to increase thrust for short periods of time during takeoff, climb, and flight. The variable exhaust nozzle 90 comprises a case or housing 94 and a plurality of independent panels or plates 92 that are pivotally connected to, or mounted on, an aft flange 95 of the housing 94 by at least one the linkage apparatuses 533. As shown in FIG. 10, one embodiment of the plate 92 comprises a first section 92A, a second section 92B pivotally connected to the first section 92A via a hinge section 92D such that the first and second sections 92A and 92B may rotate about an axis 92F when the plate 92 is actuated by one or more of the linkage apparatuses 533 and/or 633. In addition, the second section 92B may define a flared section 92C at an aft end 92E of the plate 92.

Each of the linkage apparatuses 533, or connecting rods, comprises a positioning member 532 that defines a first end 532A and a second end 532B. The first end 532A of each positioning member 532 comprises a pivot member or socket 526 having a head portion 528 and a stem 530 extending therefrom that is removably secured or threadedly received in a receiving portion 531 of the positioning member 532. The socket 526 has a bearing assembly 510 swaged therein comprising a ball (not shown) defining a bore 516 therethrough (not shown), an outer race (not shown) and a liner (not shown) disposed between the ball 512 and the outer race 514.

The linkage apparatus 533 is pivotally connected to the plate 92 and a lever or a T-bracket 91, or like bracket, via the bearing assembly 510. A shaft or pin 93A extends through the bearing assembly 510 of the linkage apparatus 533 and is received within an aperture 93B formed in the T-bracket 91 as described above with reference to pivotally connecting the bearing assembly 10 to the mounting brackets 62A and 62B via a shaft or pin 36 extending through the bearing assembly 10, and the like, as depicted in FIG. 3. The present invention is not so limited as the socket 526 and the bearing assembly 510 of the linkage apparatus 533 can be pivotally connected directly to a receiving mounting 96 extending outwardly from the plate 92. A coupling member 534 or another socket (not shown) extends from the second end 533B of each of the linkage apparatuses 533 and is removeably and securely fastened to a structural member 529, namely, the aft flange 95 of the housing 94 of the variable exhaust nozzle 90, via fasteners 548 as described above with reference to removeably and securely fastening the mounting brackets 62A and 62B to the structural member 29 by fasteners 68 threadedly received within correspondingly tapped apertures in the structural member 29, and the like, as depicted in FIG. 3. The present invention is not so limited as the coupling member 534 of the linkage apparatus 533 can be pivotally connected to a linkage assembly (not shown) that is, in turn, removeably and securely fastened to the structural member 529.

In one embodiment, the T-bracket 91 is pivotally connected to the receiving mounting 96 extending outwardly from the plate 92 via a bearing assembly 610 received within an aperture 93C formed in the T-bracket 91 and the receiving mounting 96 as described above with reference to the bearing assembly 510 of the linkage apparatus 533.

One or more additional linkage apparatuses 633 may be employed to impart rotational movement to the T-bracket 91 about the bearing assembly 610 received within the receiving mounting 96 of the plate 92 and in relation to a structural member (not shown). Each of the linkage apparatuses 633 may comprise the linkage apparatus 33 (FIG. 2), the linkage apparatus 133 (FIG. 4) or the actuator 70 (FIG. 3). In one embodiment, a first end 633A of one of the linkage apparatuses 633 is pivotally connected to an aperture 93D formed in the T-bracket 91 via a bearing assembly (not shown). In another embodiment, a first end 633A of another one of the linkage apparatuses 633 is pivotally connected to an aperture 93E formed in the T-bracket 91 via a bearing assembly (not shown).

Referring to FIGS. 9 and 10, the aft ends 92E of the plates 92 can be made to diverge and converge upon the movement of the linkage apparatuses 533 operably coupled to each plate 92 and to variable exhaust nozzle 90. Movement of each of the linkage apparatuses 533 is effected via the T-bracket 91 rotatably mounted on the plate 92. The link apparatuses 533 are coupled to the T-bracket 91 and are operably connected to one or more actuators or linkage apparatuses 633 as described above. Moving the link apparatuses 533 via the actuator(s) 633 causes rotation of the lever the T-bracket 91, which in turn causes the respective link apparatus 533 to rotate about the point at which it is coupled to the variable exhaust nozzle 90, thereby causing the aft ends 92E of the plates 92 to diverge or converge.

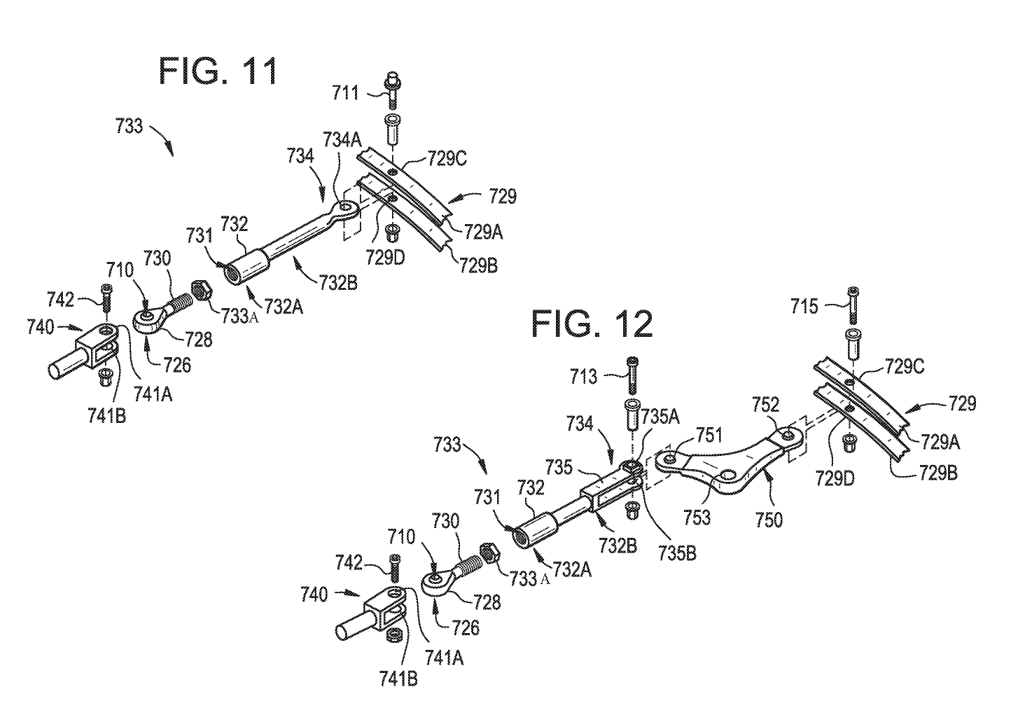

A linkage apparatus 733 depicted in FIGS. 11 and 12 is similar to the linkage apparatus 33 shown in FIG. 2, thus like elements are given a like element number preceded by the numeral 7. All of the embodiments of the linkage apparatuses 33, 133, 233, 333, 433, 533 and 633 shown in in FIGS. 6A, 6B, 6C, 7, 8, 9 and 10, optionally may instead comprise the linkage apparatus 733 shown in FIGS. 11 and 12.

As shown in FIGS. 11 and 12, the linkage apparatus 733 includes a bearing assembly 710 disposed within a socket 726 as described above with reference to bearing assembly 210 of FIG. 5. The socket 726 is defined in a first end 732A of a positioning member 732, and includes has a head portion 728 and a neck or stem 730 extending therefrom that is removably secured or threadedly received in a receiving portion 731 of the positioning member 732. In one embodiment, a nut 733 engages the stem 30 together with the receiving portion 731 of the positioning member 732. The positioning member 732 is moveable between at least a first position and a second position and thereby defining the linkage apparatus 733. The bearing 710 is configured to actuate a turbine engine component or a turbofan engine component linkage assembly that is moveable between a corresponding first and second position, such as for example, the positioning member or bar 42 of FIG. 6A, the actuator ring 44 of the VSV actuator system 40 of FIG. 6B, the VBV door assembly 57 of FIG. 6C, the turbofan engine component 80 of FIGS. 7 and 8, and the plates 92 of the variable exhaust nozzle 90 of FIGS. 9 and 10.

In one embodiment, the linkage apparatus 733 is pivotally connected to the turbine engine component via a turbofan engine component linkage assembly defined by a clevis arrangement 740. A shaft 742 is disposed through a first aperture 741A in a first flange of the clevis arrangement 740, through the bearing assembly 710, and through a second aperture 741B in a second flange of the clevis arrangement 740, thereby securing the bearing assembly 710 within the clevis arrangement 740. Accordingly, the turbine engine component is moveable between a corresponding first and second position. In one embodiment, the shaft 742 is a fastener such as for example a sleeved bolt-and-nut assembly.

The positioning member 732 of the linkage apparatus 733 defines a second end 732B defining a coupling member 734 for coupling the position member 732 to a turbofan engine structural member 729, such as for example, the structural member 86 of FIG. 6A and the actuator ring 51 of the VBV assembly 50 of FIG. 6C. The structural member 729 defines a first surface 729A (e.g., a top or forward surface) and a second surface 729B (e.g., a bottom or rearward surface). In one embodiment and as shown in FIG. 11, a shaft 711 is disposed through a first aperture 729C in the first surface 729A of the structural member 729, through an aperture 734A defined in the coupling member 734, and through a second aperture 729D in the second surface 729B of the structural member 729 thereby securing the coupling member 734 within the structural member 729. In one embodiment, the shaft 711 is a fastener such as for example a sleeved bolt-and-nut assembly.

In the embodiment and as shown in FIG. 12, the coupling member 734 is a clevis arrangement 735 fixedly connected to or integrally formed with the second end 732B of the positioning member 732. The clevis arrangement 735 is pivotally connected to a turbofan engine structural member linkage assembly such as for example a bracket link 750 that is, in turn, pivotally connected to the structural member 729. The bracket link 750 is configured to actuate the second end 732B of the positioning member 732 of the linkage apparatus 733 upon movement of the structural member 729 or another turbine engine component from a first position to a second position. Thus, the bracket link 750 optionally is configured as an L-bracket, a T-bracket, and the like.

The bracket link 750 defines a first aperture 751, a second aperture 752, and a third aperture 753. A shaft 713 is disposed through a first aperture 735A of the clevis arrangement 735, through the first aperture 751 of the bracket link 750, and through a second aperture 735A of the clevis arrangement 735 thereby securing the bracket link 750 within the clevis arrangement 735. Similarly, a shaft 715 is disposed through the first aperture 729C in the first surface 729A of the structural member 729, through the second aperture 752 of the bracket link 750, and through the second aperture 729D in the second surface 729B of the structural member 729 thereby securing the bracket link 750 within the structural member 729. In one embodiment, the shaft 713 is a fastener such as for example a sleeved bolt-and-nut assembly. In one embodiment, the shaft 715 is a fastener such as for example a sleeved bolt-and-nut assembly. In one embodiment, another turbine engine component or linkage apparatus optionally is pivotally connected to the bracket link 750 via a shaft disposed through the third aperture 753 of the bracket link 750.

One embodiment of the present invention comprises a high-cycle, short range-of-motion linkage apparatus for actuation of a turbofan engine component. The linkage apparatus comprises a pivot member having a head portion and a stem extending therefrom, an actuator moveable between at least a first position and a second position, and a spherical plain bearing secured within the head portion of the pivot member. The actuator includes a first end and a second end wherein the first end defines a receiving portion into which the stem is removably secured, and the second end defines a coupling member. The coupling member pivotally connects to a turbofan engine structural member and is moveable between at least a first position and a second position respectively corresponding to the actuator first and second positions. A spherical plain bearing is secured within the head portion of the pivot member and is pivotally connected to the turbofan engine component. The spherical plain bearing comprises an inner member, an outer member, and a liner disposed between the outer member and the inner member. The inner member defines an outer engagement surface and a bore extending at least partway therethrough. The outer member is swaged around the inner member and is disposed between the inner member and the head portion of the pivot member. The outer member defines an inner engagement surface contoured to a shape complementary to the outer engagement surface of the inner member. The liner is disposed between the inner engagement surface of the outer member and the outer engagement surface of the inner member. A shaft extends into the bore and at least one corresponding aperture in the turbofan engine component. The spherical plain bearing outer member defines a range of motion in relation to the spherical plain bearing inner member in the range of up to 90°. A second shaft extends into a second bore defined in the coupling member and at least one corresponding aperture in the turbofan engine structural member.

In one embodiment of the present invention, the outer member is swaged around the inner member by swaging the spherical plain bearing into the head portion of the pivot member.

In one embodiment of the present invention, the high-cycle, short range-of-motion linkage apparatus further comprises a first pivot member and a second pivot member. The first pivot member includes a first head portion and a first stem extending therefrom and removably secured within a first receiving portion defined in the actuator first end. The second pivot member includes a second head portion and a second stem extending therefrom and removably secured within a second receiving portion defined in the coupling member of the actuator second end. A first spherical plain bearing is secured within the first head portion of the first pivot member and pivotally connected to the turbofan engine component. A second spherical plain bearing is secured within the second head portion of the second pivot member and pivotally connected to the turbofan engine structural member.

In one embodiment of the present invention, the spherical plain bearing is pivotally connected to a turbofan engine component linkage assembly moveable between at least a first position and a second position corresponding to the actuator first and second positions. The spherical plain bearing is pivotally connected to the turbofan engine component linkage assembly by the first shaft extending into the first bore of the inner member and a first aperture defined in the turbofan engine component linkage assembly. The turbofan engine component linkage assembly is pivotally connected to the turbofan engine component by a third shaft extending into a second aperture defined in the turbofan engine component linkage assembly the at least one corresponding aperture in the turbofan engine component.

In one embodiment of the present invention, the coupling member is pivotally connected to a turbofan engine structural member linkage assembly moveable between at least a first position and a second position corresponding to the actuator first and second positions. The second shaft extends into the second bore defined in the coupling member and a first aperture defined in the turbofan engine structural member. The turbofan engine structural member linkage assembly is pivotally connected to the turbofan structural member by a third shaft extending into a second aperture defined in the turbofan engine component linkage assembly the at least one corresponding aperture in the turbofan engine component.

In one embodiment of the present invention, the turbofan engine component defines a variable-stator-vane linkage assembly and the actuator first and second positions each define one of a substantially open air flow condition and a partially closed air flow condition. Optionally, the turbofan engine structural member defines a variable-stator-vane actuator ring.

In one embodiment of the present invention, the turbofan engine component defines a variable bypass valve door assembly and the actuator first and second positions each define one of a partially open air flow condition and a closed air flow condition. Optionally, the turbofan engine structural member defines an actuator ring. Optionally, the turbofan engine structural member defines a valve door assembly linkage bracket pivotally connected to an actuator ring.

In one embodiment of the present invention, the turbofan engine component is a variable exhaust nozzle plate, and the turbofan engine structural member is a variable exhaust nozzle. The actuator first end is coupled to the variable exhaust nozzle plate, and the actuator second end is coupled to the variable exhaust nozzle.

In another embodiment, a plurality of positioning members wherein the spherical plain bearing of each positioning member engages a turbofan engine component linkage assembly.

In one embodiment of the present invention, the spherical plain bearing is operable within an operating temperature range of about 260° C. (500° F.) to about 315° C. (600° F.). In one embodiment of the present invention, the liner has an operating temperature range of about 260° C. (500° F.) to about 315° C. (600° F.). In one embodiment of the present invention, the liner comprises polytetrafluoroethylene and a polyimide resin reinforced with aramid fibers.

In one embodiment of the present invention, the actuator is operable between a retracted configuration and an extended configuration corresponding to the actuator first and second positions.

The swaged self-lubricating bearing assembly and linkage apparatus of the present invention provide an improvement over slot loader bearings or slotted entry bearings currently employed for the applications described herein such as, for example, for use within a turbofan engine.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A high-cycle, short range-of-motion linkage apparatus for actuation of a turbofan engine component, the linkage apparatus comprising:
a pivot member having a head portion and a stem extending therefrom;
an actuator moveable between at least a first position and a second position and having a first end and a second end, the actuator first end defining a receiving portion into which the stem is removably secured, the actuator second end defining a coupling member, the coupling member pivotally connected to a turbofan engine structural member and moveable between at least a first position and a second position respectively corresponding to the actuator first and second positions;
at least one spherical plain bearing secured within the head portion of the pivot member and pivotally connected to the turbofan engine component, the spherical plain bearing comprising,
an inner member having an outer engagement surface and a first bore extending at least partway therethrough,
an outer member swaged around the inner member, the outer member disposed between the inner member and the head portion of the pivot member, the outer member having an inner engagement surface contoured to a shape complementary to the outer engagement surface of the inner member,
a liner disposed between the inner engagement surface of the outer member and the outer engagement surface of the inner member, and
a first shaft extending into the first bore and at least one corresponding aperture in the turbofan engine component;
the spherical plain bearing outer member having a range of motion in relation to the spherical plain bearing inner member in the range of up to 90°; and
a second shaft extending into a second bore defined in the coupling member and at least one corresponding aperture in the turbofan engine structural member.

2. The high-cycle, short range-of-motion linkage apparatus of claim 1 wherein the outer member is swaged around the inner member by swaging the spherical plain bearing into the head portion of the pivot member.

3. The high-cycle, short range-of-motion linkage apparatus of claim 1, further comprising:
a first pivot member having a first head portion and a first stem extending therefrom and removably secured within a first receiving portion defined in the actuator first end;
a second pivot member having a second head portion and a second stem extending therefrom and removably secured within a second receiving portion defined in the coupling member of the actuator second end;
a first spherical plain bearing secured within the first head portion of the first pivot member and pivotally connected to the turbofan engine component; and
a second spherical plain bearing secured within the second head portion of the second pivot member and pivotally connected to the turbofan engine structural member.

4. The high-cycle, short range-of-motion linkage apparatus of claim 1 further comprising:
a turbofan engine component linkage assembly moveable between at least a first position and a second position corresponding to the actuator first and second positions;
wherein the at least one spherical plain bearing is pivotally connected to the turbofan engine component linkage assembly by the first shaft extending into the first bore of the inner member and a first aperture defined in the turbofan engine component linkage assembly; and
wherein the turbofan engine component linkage assembly is pivotally connected to the turbofan engine component by a third shaft extending into a second aperture defined in the turbofan engine component linkage assembly the at least one corresponding aperture in the turbofan engine component.

5. The high-cycle, short range-of-motion linkage apparatus of claim 1 further comprising:
a turbofan engine structural member linkage assembly moveable between at least a first position and a second position corresponding to the actuator first and second positions;
wherein the coupling member is pivotally connected to the turbofan engine structural member linkage assembly by the second shaft extending into the second bore defined in the coupling member and a first aperture defined in the turbofan engine structural member; and
wherein the turbofan engine structural member linkage assembly is pivotally connected to the turbofan structural member by a third shaft extending into a second aperture defined in the turbofan engine component linkage assembly the at least one corresponding aperture in the turbofan engine component.

6. The high-cycle, short range-of-motion linkage apparatus of claim 1 wherein the turbofan engine component defines a variable-stator-vane linkage assembly and the actuator first and second positions each define one of a substantially open air flow condition and a partially closed air flow condition.

7. The high-cycle, short range-of-motion linkage apparatus of claim 5 wherein the turbofan engine structural member defines a variable-stator-vane actuator ring.

8. The high-cycle, short range-of-motion linkage apparatus of claim 1 wherein the turbofan engine component defines a variable bypass valve door assembly and the actuator first and second positions each define one of a partially open air flow condition and a closed air flow condition.

9. The high-cycle, short range-of-motion linkage apparatus of claim 8 wherein the turbofan engine structural member defines an actuator ring.

10. The high-cycle, short range-of-motion linkage apparatus of claim 8 wherein the turbofan engine structural member defines a valve door assembly linkage bracket pivotally connected to an actuator ring.

11. The high-cycle, short range-of-motion linkage apparatus of claim 1 wherein the turbofan engine component defines one of an oil cooler, an air cooler, and an integrated oil/air cooler.

12. The high-cycle, short range-of-motion linkage apparatus of claim 1 wherein the turbofan engine component defines a variable exhaust nozzle plate.

13. The high-cycle, short range-of-motion linkage apparatus of claim 3 wherein:
the turbofan engine component is a variable exhaust nozzle plate;
the turbofan engine structural member is a variable exhaust nozzle;
the actuator first end is coupled to the variable exhaust nozzle plate; and
the actuator second end is coupled to the variable exhaust nozzle.

14. The high-cycle, short range-of-motion linkage apparatus of claim 1 further comprising a plurality of actuators wherein the spherical plain bearing of each actuator engages the turbofan engine component.

15. The high-cycle, short range-of-motion linkage apparatus of claim 1 wherein the spherical plain bearing is operable within an operating temperature range of about 260° C. (500° F.) to about 315° C. (600° F.).

16. The high-cycle, short range-of-motion linkage apparatus of claim 9 wherein the liner has an operating temperature range of about 260° C. (500° F.) to about 315° C. (600° F.).

17. The high-cycle, short range-of-motion linkage apparatus of claim 1 wherein the spherical plain bearing liner comprises polytetrafluoroethylene and a polyimide resin reinforced with aramid fibers.

18. The high-cycle, short range-of-motion linkage apparatus of claim 1 wherein the actuator is operable between a retracted configuration and an extended configuration corresponding to the first position and the second position of the actuator.

19. A high-cycle, short range-of-motion linkage apparatus for actuation of a turbofan engine component linkage assembly, the linkage apparatus comprising:
a pivot member having a head portion and a stem extending therefrom;
an actuator moveable between at least a first position and a second position and having a first end and a second end, the actuator first end defining a receiving portion into which the stem is removably secured, the actuator second end defining a coupling member moveable between at least a first position and a second position respectively corresponding to the actuator first and second positions;
a spherical plain bearing secured within the head portion of the pivot member and operable within an operating temperature range of about 260° C. (500° F.) to about 315° C. (600° F.), the spherical plain bearing comprising,
an inner member having an outer engagement surface and a first bore extending at least partway therethrough,
an outer member swaged around the inner member, the outer member disposed between the inner member and the head portion of the pivot member, the outer member having an inner engagement surface contoured to a shape complementary to the outer engagement surface of the inner member,
a liner comprising polytetrafluoroethylene and a polyimide resin reinforced with aramid fibers having an operating temperature range of about 260° C. (500° F.) to about 315° C. (600° F.) and disposed between the inner engagement surface of the outer member and the outer engagement surface of the inner member, and
the spherical plain bearing outer member having a range of motion in relation to the spherical plain bearing inner member in the range of up to 90°; and
a first shaft extending into the first bore and at least one corresponding aperture in the turbofan engine component linkage assembly and pivotally connecting the actuator first end to the turbofan engine component linkage assembly; and
a second shaft extending into a second bore defined in the coupling member and at least one corresponding aperture in a turbofan engine structural member linkage assembly and pivotally connecting the coupling member to the turbofan engine structural member linkage assembly.
